(19) United States
(12) Patent Application Publication
(10) Pub. No.: US 2007/0127431 A1
(43) Pub. Date: Jun. 7, 2007

(54) Method and apparatus for generating pseudorandom binary sequence in communication system using linear feedback shift register

(75) Inventors: Yoo-Chang Eun, Seoul (KR); Jong-Han Lim, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/598,027

(22) Filed: Nov. 13, 2006

(30) Foreign Application Priority Data
Nov. 11, 2005 (KR) 2005-108268

(51) Int. Cl. H04B 7/216; H04L 12/26

(52) U.S. Cl. 370/342; 370/249

(57) ABSTRACT

A method and apparatus for generating a code after a random time in a communication system using an n-stage Linear Feedback Shift Register (LFSR) are provided. The method includes expressing an element indicating the current state value of the LFSR in a finite field GF(2ⁿ), performing a 2^{r}-th power operation and a multiply operation with respect to the characteristic polynomial using the LFSR when n=rs in the GF(2ⁿ), and repeating the 2^{r}-th power operation and the multiply operation s times to calculate a new state value of the LFSR after the random time, thereby generating the code.

### PRIORITY

This application claims the benefit under 35 U.S.C. § 119(a) of a Korean Patent Application, Serial No. 2006-108268 filed in the Korean Intellectual Property Office on Nov. 11, 2005, the entire contents of which is hereby incorporated by reference.

### BACKGROUND OF THE INVENTION

1. Field of the Invention

The present invention generally relates to a Linear Feedback Shift Register (LFSR). More particularly, the present invention relates to a method and apparatus for generating a pseudorandom binary sequence by quickly calculating a state of an LFSR used for code generation in a communication system using an LFSR.

2. Description of the Related Art

An LFSR refers to a circuit for generating a pseudorandom binary sequence of a binary bitstream sequenced using linear feedback. In this circuit, the contents of multiple shift registers are individually shifted according to a clock cycle. Output values and exclusive logic OR operation values of the shift registers are simultaneously applied as inputs to the shift registers. The LFSR is widely used to encrypt or synchronize data for transmission. The LFSR, for example, is applied to a Pseudo Noise (PN) generator in a Code Division Multiple Access (CDMA) mobile communication system such as a CDMA-2000 system or Universal Mobile Telecommunication System (UMTS).

Various techniques to reduce power consumption have been applied to terminals in the CDMA mobile communication system. An example of one of these techniques is a sleep-mode operation. A method for reducing power consumption in the sleep mode has also been considered. A clock for driving an LFSR included in the PN generator is provided by a Temperature Compensated Crystal Oscillator (TCXO) that operates at high speeds. In the sleep mode, the TCXO operates at low speeds and the power of the LFSR is shut down, thereby reducing power consumption. For example, in a CDMA-2000 1× system, a long PN code is generated by a high-speed 42-stage LFSR operating at a speed of 1.2288 Mchip/sec and in the sleep mode, the power of the LFSR is shut down and the elapsed amount of time is counted using a low-speed clock instead of a high-speed clock. At this time, if the terminal repeats sleep and wake-up operations according to a fixed cycle, a state of the LFSR to be used after the wake-up may be calculated using a mask pattern that advances a state of the LFSR by the number of chips corresponding to the sleep time.

If the LFSR wakes up from the sleep mode according to a fixed cycle, the devices illustrated in FIGS. 1 and 2 calculate a state of the LFSR to be used after the LFSR wakes up from the sleep mode using a fixed mask pattern. FIG. 1 is a block diagram of an example of a device for calculating a state of a PN generator according to the prior art. The device illustrated in FIG. 1 calculates a state of a 4-stage LFSR using a Fibonacci connection.

Referring to FIG. 1, the device extracts the current state of the LFSR by using a given mask pattern and calculates a state of the LFSR corresponding to time after a lapse of time the mask pattern means based on the extracted state. In a state in which SW1 and SW2 are closed and SW3 is opened, a desired state in buffers R₃, R₂, R₁, and R₀ for a first chip through a fourth chip. In contrast, in a state in which SW1 and SW2 are opened and SW3 is closed, R₃, R₂, R₁, and R₀ values are sequentially filled in registers S₃, S₂, S₁, and S₀ of the LFSR for a fifth chip through an eighth chip. Although R₃, R₂, R₁, and R₀ values are serially input to S₃, S₂, S₁, and S₀, they may also be input at any time. From a ninth chip, since the desired state is filled in S₃, S₂, S₁, and S₀, the LFSR is driven normally in a state in which only SW1 is closed.

If the device illustrated in FIG. 1 is extended to another application, a desired state of an n-stage LFSR can be acquired after {2n} chips. Thus, if the device is driven at the speed analogous to the chip rate of the LFSR and the LFSR has to wake up from the sleep mode after T chips from the start point of the sleep mode, the device can be driven after {T−2n} chip from the sleep point using a mask pattern that advances T. If the device is driven at a higher speed than the chip rate of the LFSR during an LFSR state calculation period and the time required for the operation of the device is x(<2n) chips, the device can initiate its operation after {T−x} chips from the start point of the sleep mode.

FIG. 2 is a block diagram of another example of a device for calculating a state of a PN generator according to the prior art. The device calculates a state of a 4-stage LFSR using a Galois connection.

Referring to FIG. 2, the device calculates R₃, R₂, R₁, and R₀ values similar to the device illustrated in FIG. 1. The device linearly combines R₃, R₂, R₁, and R₀ values to acquire R′₃, R′₂, R′₁, and R′₀ values and sequentially inputs R′₃, R′₂, R′₁, and R′₀ values to registers S₃, S₂, S₁, and S₀ of the LFSR. Although R′₃, R′₂, R′₁, and R′₀ values are serially input to S₃, S₂, S₁, and S₀, proper linear combinations of R₃, R₂, R₁, and R₀ values corresponding to R′₃, R′₂, R′₁, and R′₀ values may be directly input to S₃, S₂, S₁, and S₀ for parallel input.

FIG. 3 illustrates a conventional processing flowchart for calculating a state of an n-stage LFSR after a random time t(=(tₙ₋₁, tₙ₋₂, . . . t₀)₂), instead of a fixed time, from the start point of the sleep mode unlike the devices illustrated in FIGS. 1 and 2. The processing flowchart corresponds to a case in which a direct multiply method is used on a finite field GF(2ⁿ).

To map a state of the LFSR to elements of GF(2ⁿ), a primitive element α of GF(2ⁿ) may be defined as a root that satisfies an LFSR connection polynomial. Immediately prior to feedback, a register may be an MSB in the LFSR using a Galois connection and registers are sequentially S₃, S₂, S₁, and S₀ from the MSB in a 4-stage LFSR, when mapping is performed as follows:
α³ is (S₃, S₂, S₁, S₀)=(1, 0, 0, 0)
α² is (S₃, S₂, S₁, S₀)=(0, 1, 0, 0)
α¹ is (S₃, S₂, S₁, S₀)=(0, 0, 1, 0)
α⁰ is (S₃, S₂, S₁, S₀)=(0, 0, 0, 1),
In this case, an element of GF(2ⁿ) can be expressed by linear combination of the basis. Thus, the current binary state of the LFSR is mapped to a specific element of GF(2ⁿ), namely β, as a linear combination of the basis and a 1-chip shift of the LFSR is equivalent to “β·α”.

Referring to FIG. 3, an LFSR state is mapped to an element β on GF(2ⁿ) in step 33 and the element β is multiplied by a t-th power of a primitive element α, i.e., α^{t}. The multiplication result is de-mapped to the LFSR state to acquire a desired result in step 43. α^{t} is not used to reduce the amount of computation. However, α²^{^{t}} that is previously stored in a table in the form of an n-tuple vector with respect to a range of 0≦i≦(n−1) is used in step 31 to reduce the amount of computation. In other words, since βα^{t}=βα^{t}^{_{n−1}}²^{^{n−1}} α^{t}^{_{n−2}}²^{^{n−2}} . . . α^{t}^{₁}^{²}α^{t}^{⁰}, instead of calculating βα^{t}, i is increased by 1 in step 41. When tᵢ is equal to 1 (an example of step 35), α²^{ⁱ} stored in the table is accumulatively multiplied in steps 36 through 40. In order to multiply β expressed as a binary n-tuple vector representing the state of the LFSR by the n-tuple vector α²^{ⁱ}(=Aᵢ) which is also expressed as an n-tuple vector over the same αⁿ⁻¹, αⁿ⁻², . . . 1 basis, n shift operations y=(y<<1)modf(x) and a bitwise exclusive logic OR operation y=y⊕β which is performed only when an (n−j+1)th bit of Aᵢ, such as, Aᵢ(n−j+1), is equal to 1 in steps 38 and 39. f(x) in step 38 indicates a characteristic polynomial. For example, the LFSR in FIG. 2 has f(x)=x⁴+x+1 satisfying α⁴+α+1=0. If y represent a state of LFSR, step 38 corresponds to the same operation as shift the LFSR by one chip or y=y·α. Thus, n² loops may be performed in the worst case and an average of n²/2 loops should be performed to acquire the LFSR state using the direct multiply method on the finite field GF(2ⁿ) described above.

According to the method of FIG. 3, the LFSR state is calculated after a random time is implemented with software and the complexity of time then significantly increases. In other words, n loops have to be performed for each of variants i and j in FIG. 3, resulting in a time complexity of O(n²). Since power and Central Processing Unit (CPU) resources can be saved as the time required for an operation decreases, there is a need for a method for reducing the amount of computation in the operation of calculating the LFSR state illustrated in FIG. 3.

Accordingly, there is a need for an improved system and method for generating a pseudorandom binary sequence in a communication system so that a state of a Linear Feedback Shift Register (LFSR) may be calculated quickly.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a method and apparatus for generating a pseudorandom binary sequence in a communication system, in which a state of a Linear Feedback Shift Register (LFSR) after a random time can be calculated quickly.

To achieve the above and other objects, there is provided a method for generating a code after a random time in a communication system using an n-stage binary Linear Feedback Shift Register (LFSR). The method comprises defining an element indicating the current state value of the LFSR in a finite field GF(2ⁿ), performing a 2^{r}-th power operation and a multiply operation with respect to a characteristic polynomial of the LFSR when n=rs in the GF(2ⁿ) where r and s are selected values, and repeating the 2^{r}-th power operation and the multiply operation s times to calculate a new state value of the LFSR after the random time, thereby generating the code.

To achieve the above and other objects, there is provided an apparatus for generating a code after random time in a communication system using an n-stage binary Linear Feedback Shift Register (LFSR), the apparatus comprises a first shift register logic for performing a 2^{r}-th power operation with respect to a characteristic polynomial comprising elements indicating the current state value of the LFSR when n=rs in a finite field GF(2ⁿ) when the characteristic polynomial is expressed with elements of the GF(2ⁿ) and r and s are selected values, and a second shift register logic for performing a multiply operation with respect to the result of the 2^{r}-th power operation by shifting the LFSR. Wherein the first shift register logic and the second shift register logic repeat the 2^{r}-th power operation and the multiply operation s times to calculate a new state value of the LFSR after the random time, thereby generating the code.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other exemplary objects, features and advantages of certain exemplary embodiments of the present invention will be more apparent from the following description taken in conjunction with the accompanying drawings, in which:

FIG. 1 is a block diagram of an example of a device for calculating a state of a Pseudorandom Noise (PN) generator according to the prior art;

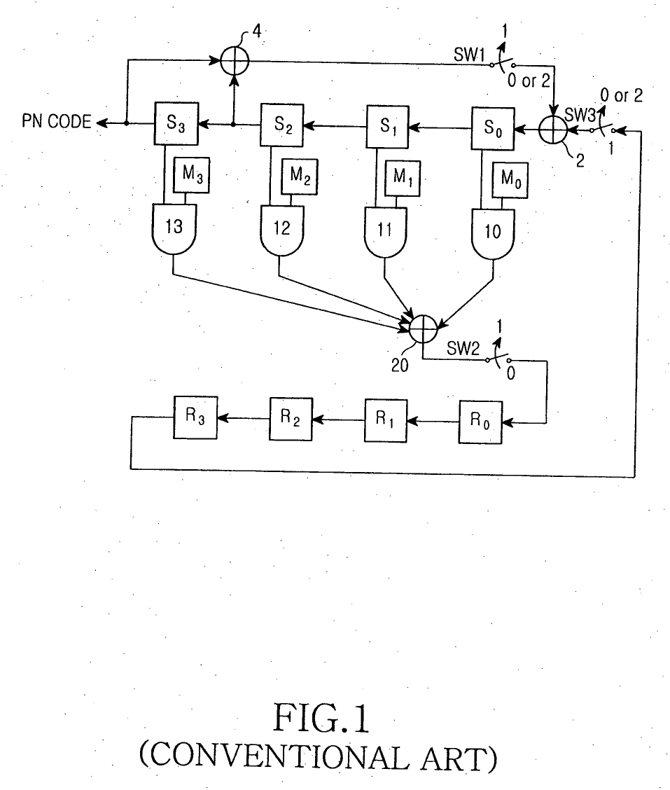

FIG. 2 is a block diagram of another example of a device for calculating a state of a PN generator according to the prior art;

FIG. 3 is a flowchart illustrating another example of a processing flow for calculating a state of a PN generator according to the prior art;

FIG. 4 is a flowchart illustrating a processing flow for calculating a state of a PN generator according to an exemplary embodiment of the present invention;

FIGS. 5A and 5B illustrate the logic of shift registers for performing a multiply operation and a square operation according to the processing flow of FIG. 4;

FIG. 6 is a block diagram of a device for calculating a state of a PN generator according to an exemplary embodiment of the present invention;

FIG. 7 is a signal timing diagram for state calculation by the device of FIG. 6;

FIG. 8 is a flowchart illustrating a processing flow for calculating a state of a PN generator according to another exemplary embodiment of the present invention;

FIG. 9 illustrates the logic of a shift register for performing a power operation according to the processing flow of FIG. 8; and

FIG. 10 illustrates values required for a 2⁶-th power operation during generation of a pseudorandom binary sequence using a 42-stage LFSR according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

A new algorithm and hardware structure for quickly calculating a state of an LFSR used as a Pseudorandom Noise (PN) generator of a mobile communication after random time according to the principle of an exemplary embodiment of the present invention will be suggested.

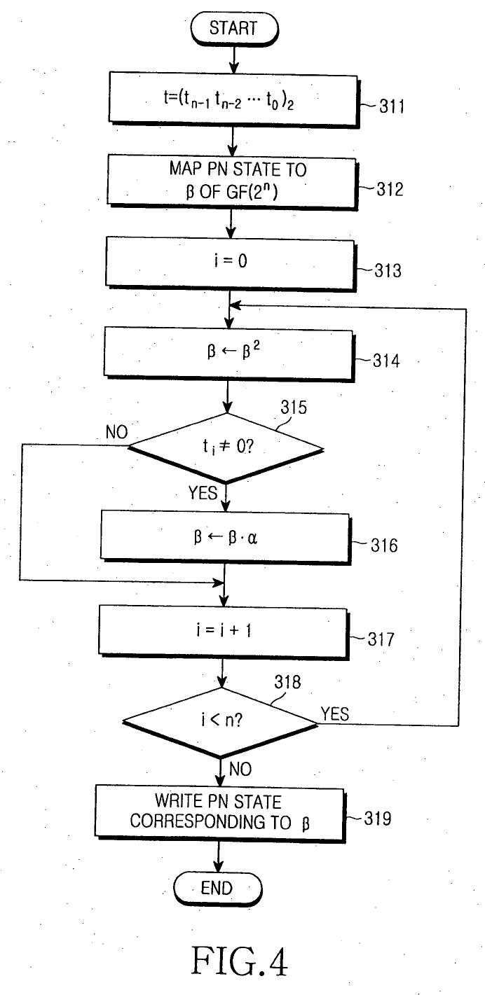

According to an exemplary embodiment of the present invention, a square-and-multiply method that can be implemented for a short period of time, i.e., 2n chip time, without referring to memory and a device implemented with the square-and-multiply method is proposed. The square-and-multiply method, which will be described with reference to FIGS. 4 through 7, enables high-speed processing for a searcher and finger assignment and reduces the operation time of a terminal in sleep/idle modes provided to reduce power consumption, thereby effectively reducing power consumption.

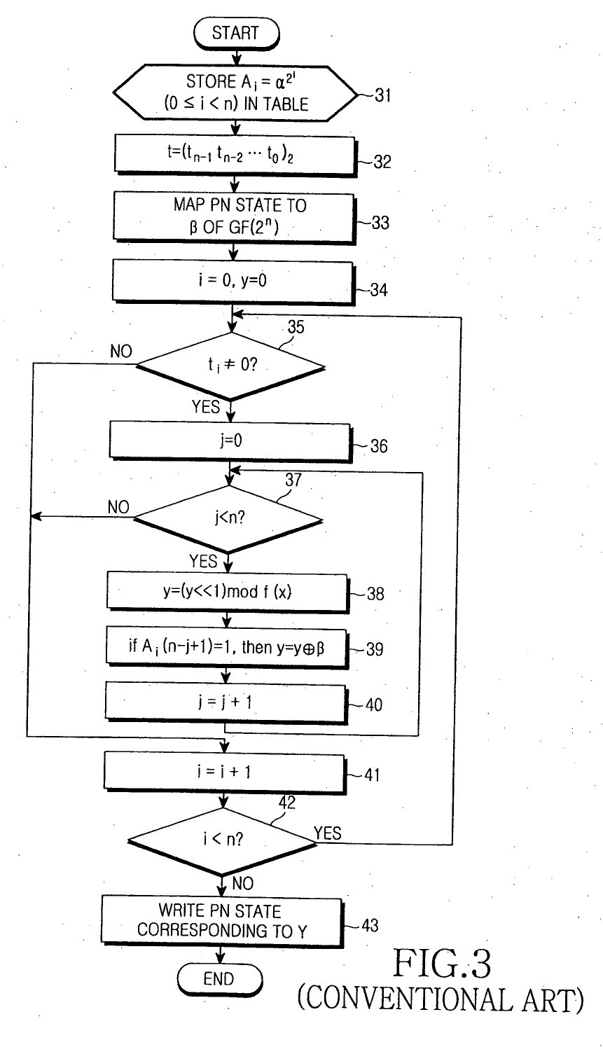

According to another exemplary embodiment of the present invention, a power-and-multiply method is proposed in which a 2^{r}-th power operation and some multiply operations are performed in the case of r|n by improving the direct multiply method used on a finite field similar to that of FIG. 3. According to the power-and-multiply method, an LFSR state, after a random time, can be calculated faster and more efficiently than the square-and-multiply method in terms of general-purpose CPU operation.

A. Square-and-Multiply Method

The following description, with reference to FIGS. 4 through 7, will provide a new square-and-multiply method by which a state of an LFSR after a random time can be directly calculated.

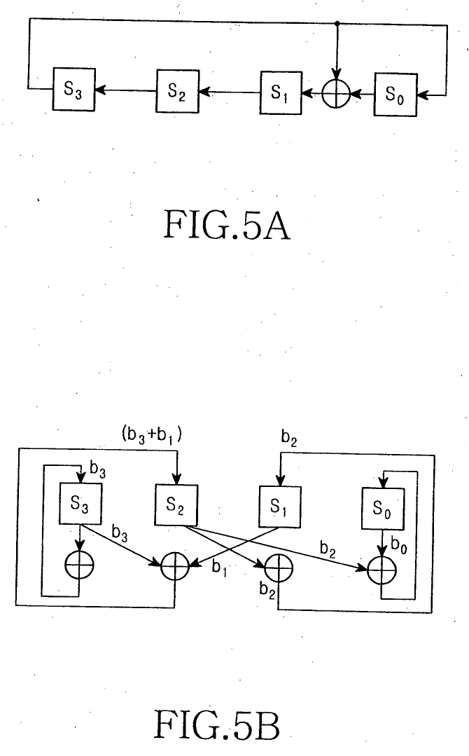

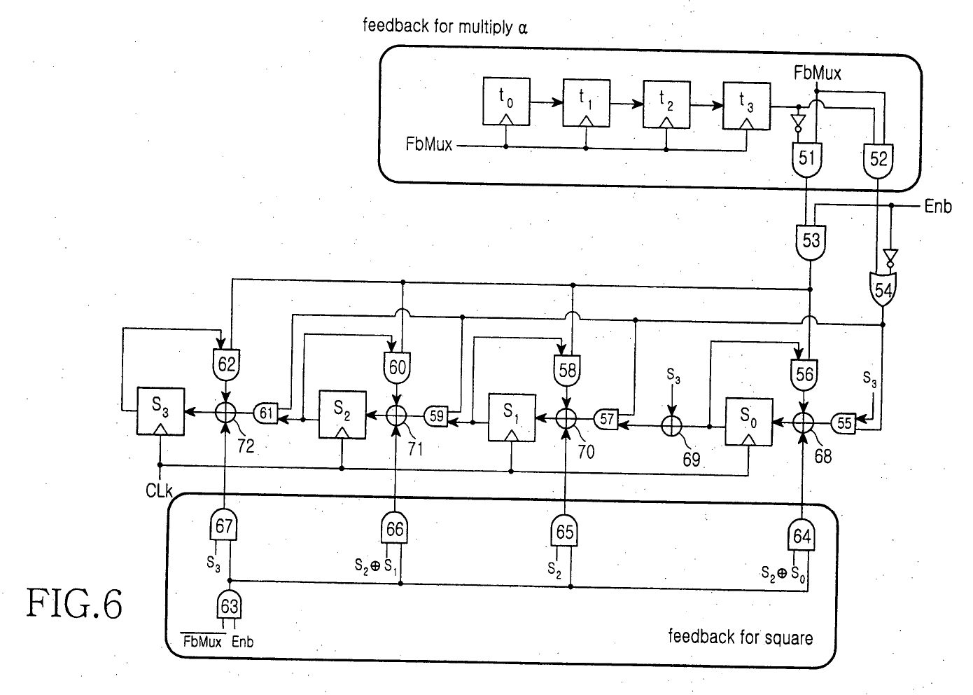

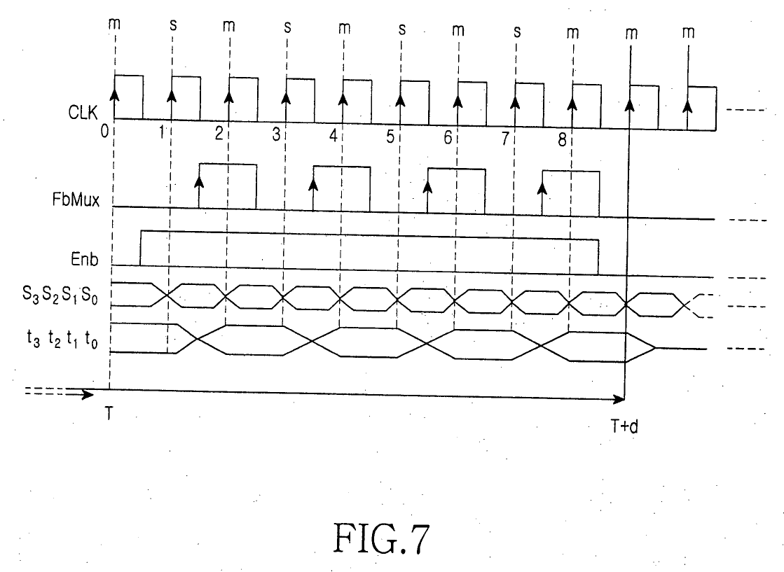

FIGS. 4 and 6 illustrate the flow of an algorithm and the structure of hardware device for directly calculating a state of an LFSR using the square-and-multiply method. When the algorithm of FIG. 4 is implemented with the hardware device of FIG. 6, an n-stage LFSR can rapidly slew to a random state after 2n shifts. FIGS. 5A and 5B illustrate, for example, the logics of shift registers for performing a multiply operation and a square operation in the case in which n=4. FIG. 7 is a signal timing diagram for state calculation by the device of FIG. 6.

If an initial value of an n-stage LFSR using Galois connection is not 0, a state of the LFSR that is output after the LFSR′s shifting corresponds to all elements of GF(2ⁿ) except for 0 based on one-to-one correspondence. For example, when the primitive element of GF(2⁴) is α, if (0010) among the states of the LFSR corresponds to the primitive element α, a state (α₃α₂α₀) of the LFSR can be expressed as follows:
α₃α³+α₂α²+α₁α¹+α₀ε Eelements of GF(2⁴) (1)

When it is assumed that α₃α³+α₂α²+α₁α¹+α₀=α^{x}, a state of the LFSR after t chips, which means a state of the LFSR after t shifts, can be expressed as follows:

$$\begin{matrix}{α}^{x} {α}^{t} = {α}^{x + t} \\ = {α}^{t} ( {a}_{3} {α}^{3} + {a}_{2} {α}^{2} + {a}_{1} α + {a}_{0} ) \\ = {a}_{3} {α}^{t + 3} + {a}_{2} {α}^{t + 2} + {a}_{1} {α}^{t + 1} + {a}_{0} {α}^{t}\end{matrix} \qquad ( 2 )$$

To express a state of α^{x} after t chips is equivalent to expressing Equation (2) with a linear combination of α³, α², α, and 1, as follows:

$$\begin{matrix}{α}^{x} {α}^{t} = {a}_{3} {α}^{t + 3} + {a}_{2} {α}^{t + 2} + {a}_{1} {α}^{t + 1} + {a}_{0} {α}^{t} \\ = {a}_{3}^{′} {α}^{3} + {a}_{2}^{′} {α}^{2} + {a}_{1}^{′} {α}^{1} + {a}_{0}^{′}\end{matrix} \qquad ( 3 )$$

When a state of α^{x} after t chips is expressed as illustrated in Equation (3), (α′₃ α′₂ α′₁ α′₀) is a state of the LFSR after t chips.

For example, for a 4-stage LFSR, α^{x+t} when t=t₀+t₁2+t₂2²+t₃2³ can be calculated by repeating a square operation and a multiply operation by α as follows:
((((α^{x})²α^{t}^{₃})²α^{t}^{₂})²α^{t}^{₁})²α^{t}^{₀}=(α^{x})²^{⁴}α^{t}=α^{x}α^{t} (4)

In Equation (4), a second term in the middle portion uses a feature that an element β in the GF(2ⁿ) is equal to β²^{ⁿ}. Thus, Equation (4) can be calculated by using only the square operation and the multiply operation by α. The processing flow for the square operation and the multiply operation by a is illustrated in FIG. 4.

Referring to FIG. 4, a controller or processor (not shown) takes the time of t chips (t=(tₙ₋₁tₙ₋₂ . . . tᵢ . . . t₀)₂) among time intervals of a sleep mode to calculate a state of the LFSR after t chips from the current state of the LFSR in step 311. In step 312, the controller maps a PN state to an element β in the GF(2ⁿ). In step 313, the controller sets a parameter i to 0. In step 314, the controller replaces β² with β. In step 315, the controller determines whether tᵢ=0. If it is determined that tᵢ=0 in step 315, the controller proceeds to step 317. Otherwise, the controller proceeds to step 317 after performing step 316. In step 316, the controller replaces {β·α} with β. Since the controller performs steps 314 through 316 with respect to (i) in step 317, it performs steps 314 through 316 after increasing (i) by 1. Such an operation of the controller is repeated until it is determined that (i) is not less than n in step 318. If it is determined that (i) is not less than n, such as, (i) is equal to or greater than n in step 318, the controller writes a PN state corresponding to β 319 and terminates its operation.

As in Equation (4), for the 4-stage LFSR, α^{x+t} in a case in which t=t₀+t₁2+t₂2²+t₃2³ can be calculated by repeating the square operation and the multiply operation by α. The multiply operation has the same result as that of an LFSR using a Galois connection that is shifted once, which can be implemented with the logic of a shift register as illustrated in FIG. 5A.

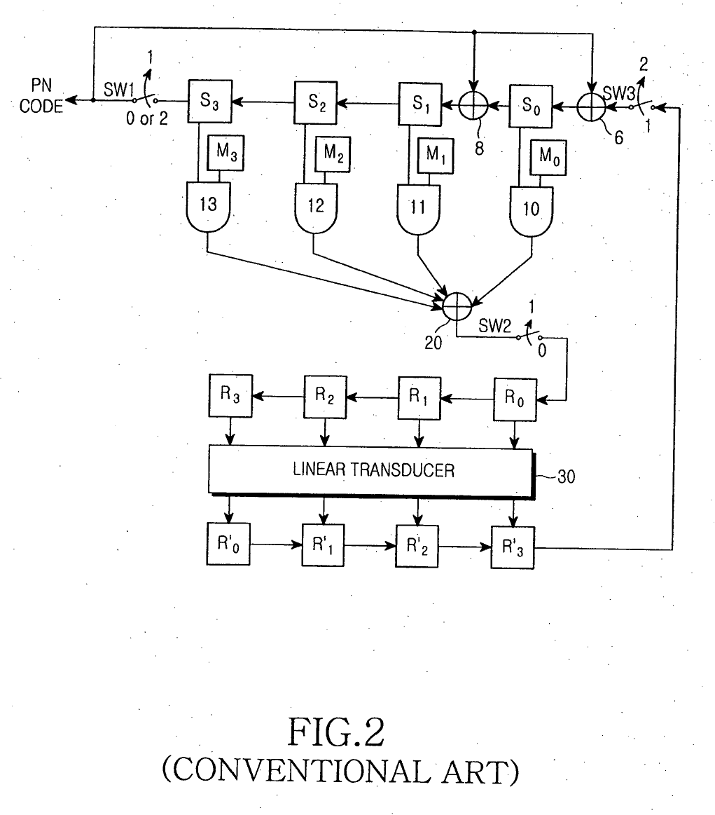

In contrast, the square operation can be performed as follows. If the characteristic polynomial of the LFSR using the Galois connection in which elements of GF(2⁴) are expressed is x⁴+x+1 as in FIG. 2, a primitive element α satisfies α⁴+α+1=0. If β=b₃α³+b₂α²+b₁α+b₀ and bᵢε{0,1}, β² is expressed as follows, due to characteristic of a finite field multiply operation in which a characteristic value is 2:

$$\begin{matrix}{β}^{2} = {( {b}_{3} {α}^{3} + {b}_{2} {α}^{2} + {b}_{1} α + {b}_{0} )}^{2} \\ = {b}_{3} {α}^{6} + {b}_{2} {α}^{4} + {b}_{1} {α}^{2} + {b}_{0}\end{matrix} \qquad ( 5 )$$

In Equation (5), since the first equality is (b₃α³)²+(b₂α²)²+(b₁α)²+(b₀)² and b₃, b₂, b₁, and b₀ are equal to 0 or 1, it can be expressed as the second equality. In addition, in Equation (5), since α⁶=α³+α² and α⁴=α+1, Equation (5) can be expressed as Equation (6) which can be implemented with the logic of a shift register as illustrated in FIG. 5B.
β²=b₃α³+(b₃+b₁)α²+b₂α+(b₂+b₀) (6)
α^{x}α^{t}=((((α^{x})²α^{t}^{₃})²α^{t}^{₂})²αt^{₁})²α^{t}^{₀} in Equation (4) can be implemented by repetitively applying the square operation that can be implemented with the logic illustrated in FIG. 5A and the multiply operation that can be implemented with the logic illustrated in FIG. 5B. FIG. 6 is a block diagram of a device for calculating a state of an LFSR using the square operation and the multiply operation and FIG. 7 is a signal timing diagram for state calculation by the device of FIG. 6.

Referring to FIG. 6, the device includes shift registers S₀, S₁, S₂, and S₃ for a 4-stage LFSR. The shift register S₀ receives an output of an exclusive logic OR operator 68 and outputs the received output according to a clock CLK. The exclusive logic OR operator 68 receives an output of a logic AND operator 55, an output of a logic AND operator 56, and an output of a logic AND operator 64 and performs an exclusive logic OR operation with respect to the received outputs. The logic AND operator 55 receives an output of a logic OR operator 54 and an output of the shift register S₃ and performs a logic AND operation with respect to the received outputs. The logic OR operator 56 receives an output of a logic AND operator 53 and an output of the shift register S₀ and performs a logic AND operation with respect to the received outputs. The logic AND operator 64 receives a result of an exclusive logic OR operation with respect to outputs of the shift registers S₀ and S₂ and an output of a logic AND operator 63 and performs a logic AND operation with respect to the received result and output. An exclusive logic OR operator 69 receives the output of the shift register S₀ and the output of the shift register S₃ and performs an exclusive logic OR operation with respect to the received outputs. A logic AND operator 57 receives the output of the exclusive logic OR operator 69 and the output of the logic OR operator 54 and performs a logic AND operation with respect to the received outputs. An exclusive logic OR operator 70 receives the output of the logic AND operator 57, an output of a logic AND operator 58, and an output of a logic AND operator 65 and performs an exclusive logic OR operation with respect to the received outputs. A logic AND operator 58 receives the output of the shift register S₁ and the output of the logic AND operator 53 and performs a logic AND operation with respect to the received outputs. The logic AND operator 65 receives the output of the shift register S₂ and the output of the logic AND operator 63 and performs a logic AND operation with respect to the received outputs.

The shift register S₁ receives the output of the exclusive logic OR operator 70 and outputs the received output according to a clock CLK. A logic AND operator 59 receives the output of the shift register S₁ and the output of the logic OR operator 54. The logic AND operator 59 a logic AND operation with respect to the received outputs. An exclusive logic OR operator 71 receives an output of the logic AND operator 59, an output of a logic AND operator 60, an output of a logic AND operator 66 and performs an exclusive logic OR operation with respect to the received outputs. The logic AND operator 60 receives the output of the shift register S₂ and the output of the logic AND operator 53 and performs a logic AND operation with respect to the received outputs. The logic AND operator 66 receives a result of an exclusive logic OR operation with respect to the outputs of the shift registers S₁ and S₂ and the output of the logic AND operator 63 and performs a logic AND operation with respect to the received result and output.

The shift register S₂ receives an output of the exclusive logic OR operator 71 and outputs the received output according to a clock CLK. The logic AND operator 61 receives the output of the shift register S₂ and the output of the logic OR operator 54. The logic AND operator 61 also performs a logic AND operation with respect to the received outputs. An exclusive logic OR operator 72 receives the output of the logic AND operator 61, the output of the logic AND operator 62, and the output of the logic AND operator 67 and performs an exclusive logic OR operation with respect to the received outputs. The logic AND operator 62 receives the output of the logic AND operator 53 and the output of the shift register S₃ and performs a logic AND operation with respect to the received outputs. The logic AND operator 67 receives the output of the shift register S₃ and the output of the logic AND operator 63 and performs a logic AND operation with respect to the received outputs. The shift register S₃ receives the output of the exclusive logic AND operator 72 and outputs the received output according to a clock CLK.

The logic AND operator 53 receives the output of the logic AND operator 51 and an enable signal Enb. The logic AND operator 53 then performs a logic AND operation with respect to the received output and enable signal Enb. The logic OR operator 54 receives the output of the logic AND operator 52 and an inverted enable signal. The logic OR operator then performs a logic OR operation with respect to the received output and inverted enable signal. The logic AND operator 52 receives a selection signal FbMux and an output of a flip-flop t₃ and performs a logic OR operation with respect to the received selection signal and output. The logic AND operator 51 receives the selection signal FbMux and the output of the flip-flop t₃ that passes through an inverter and performs a logic AND operation with respect to the received selection signal and output. Flip-flops t₃, t₂, t₁, and t₀ that are connected in series operate according to the selection signal FbMux.

The logic AND operators 63 through 67 are used for a square operation and the flip-flops t₃, t₂, t₁, and to and the logic AND operators 51 and 52 are used for a multiply operation.

Referring to FIGS. 6 and 7, the enable signal Enb determines whether to perform the square operation and the multiply operation and the selection signal FbMux determines whether to perform the square operation or the multiply operation. When the enable signal Enb is equal to 1, the square operation and the multiply operation similar to Equation (4) are performed. When the selection signal FbMux is equal to 0, the square operation is performed. When the selection signal FbMux is equal to 1, the multiply operation is performed. The multiply operation varies with tᵢ. When tᵢ is equal to 0, the multiply operation by 1 is performed. When tᵢ is equal to 1, the multiply operation by α is performed. The square operation and the multiply operation require a fixed {2n} chip time for an n-stage LFSR. According to an exemplary implementation, {2n} shifts are required. For example, for the 4-stage LFSR as illustrated in FIG. 6, the square operation and the multiply operation require 8 shifts, and thus 8 pulses are required in a clock CLK. In a slew operation, such a fixed operation delay is added to t.

B. Power-and-Multiply Method

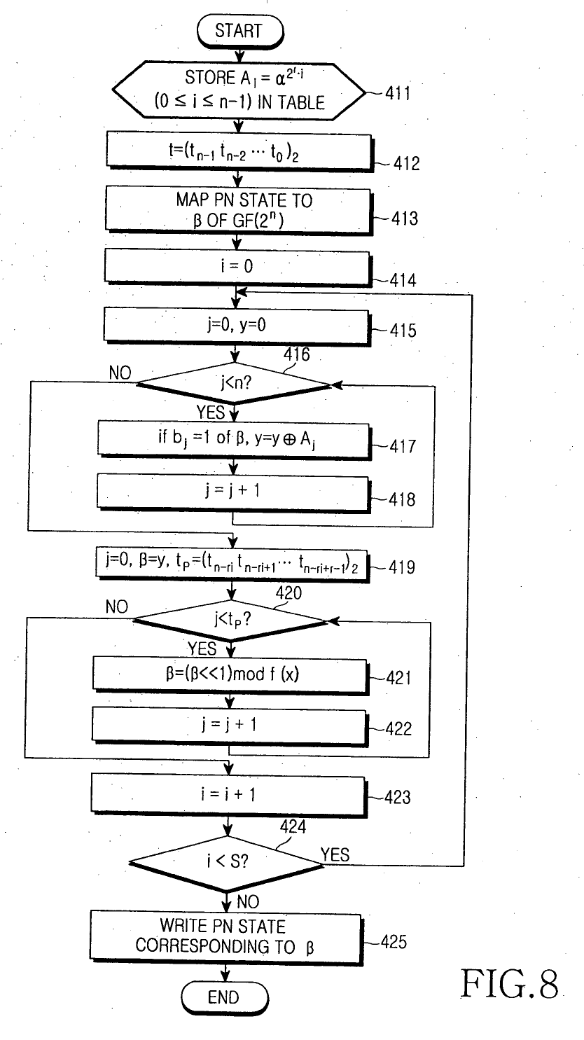

The following description with reference to FIGS. 8 through 10 will provide a new power-and-multiply method for directly calculating a state of an LFSR after a random time. According to the current exemplary embodiment of the present invention, a method for calculating a state of an LFSR after a random time has the following characteristics.

(1) When n=rs for an n-stage LFSR, a 2^{r}-th power operation and a multiply operation are performed.

(2) The 2^{r}-th power operation and the multiply operation are repetitively performed.

(3) To reduce complexity of the 2^{r}-th power operation, α²^{^{r}}^{·i}(=Aᵢ) for 0≦i≦n−1 is previously stored for use.

According to an exemplary implementation, a value that is previously stored in a table in the form of an n-tuple vector is used as a α²^{^{r}}^{·i}(=Aᵢ) and the variable i denotes a parameter for distinguishing r for the power operation and the multiply operation that are performed s times

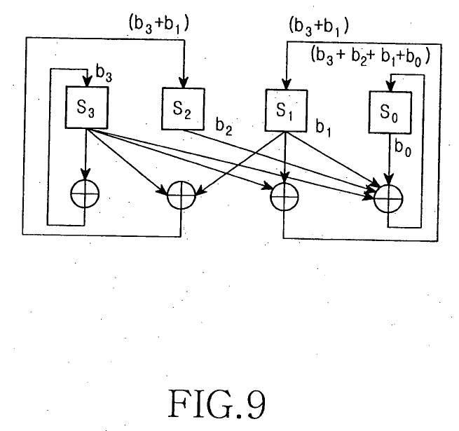

FIG. 8 is a flowchart illustrating a processing flow for calculating a state of a PN generator according to another exemplary embodiment of the present invention, and FIG. 9 illustrates the logic of a shift register for performing a power operation according to the processing flow of FIG. 8.

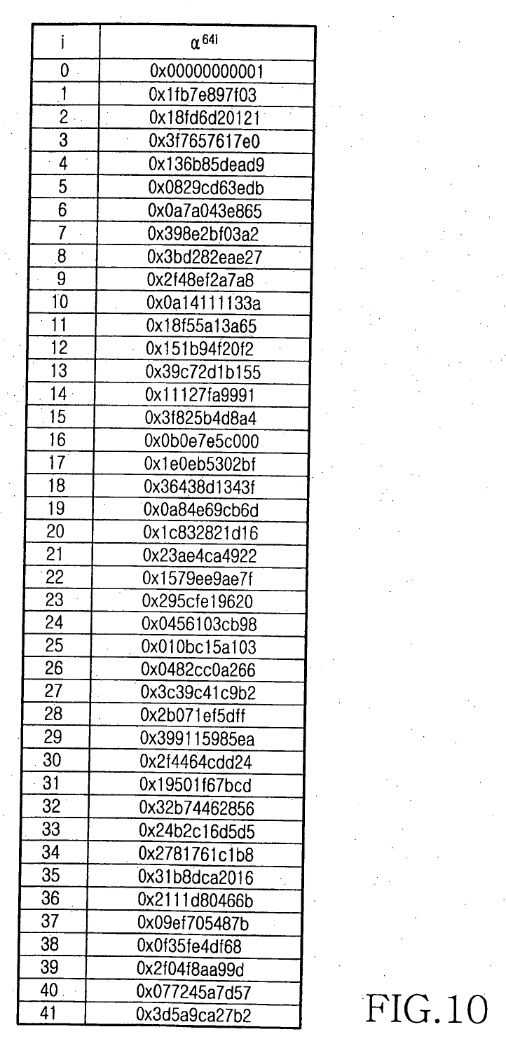

FIG. 10 illustrates values required for a 2⁶(=64)-th power operation during the generation of a pseudorandom binary sequence using a 42-stage LFSR according to an exemplary embodiment of the present invention. More specifically, FIG. 10 illustrates information required when a state of a 42-stage LFSR for generating a long code in an IS-95 and Code Division Multiplexing Access (CDMA)-2000 system is provided according to the processing flow of FIG. 8. For example, FIG. 10 illustrates the binary 42-tuple vector α⁶⁴ⁱ on a {α⁴², α⁴¹, . . . , 1} basis required for a 64-th power operation in forms of the hexadecimal numbers when r=6.

According to an exemplary embodiment of the present invention, a state of an LFSR may be quickly calculated by using a 4-th power operation instead of a square operation when n=4. Equation (7) below illustrates a process of calculating a state of an LFSR using a 2²(=4)-th power operation when n=4.
α^{x}α^{t}=((α^{x})²^{²}α^{2t}^{₃}^{+t}^{₂})²^{²}α^{2t}^{₁}^{+t}^{₀} (7)

When β=b₃α³+b₂α²+b₁α+b₀ and bᵢε{0,1}, the 4-th power operation with respect to β is expressed as follows:

$$\begin{matrix}{β}^{4} = {( {b}_{3} {α}^{3} + {b}_{2} {α}^{2} + {b}_{1} α + {b}_{0} )}^{4} \\ = {b}_{3} {α}^{12} + {b}_{2} {α}^{8} + {b}_{1} {α}^{4} + {b}_{0}\end{matrix} \qquad ( 8 )$$

Since α¹²=α³+α²+α+1, α⁸=α²+1, and α⁴=α+1, Equation (8) can be expressed as follows:
β⁴=b₃α³+(b₃+b₂)α²+(b₃+b₁)α+(b₃+b₂+b₁+b₀) (9)

The logic of a shift register for the 4-th power operation is illustrated in FIG. 9.

As another example, a process of calculating a state of an LFSR using a 2³(=8)-th power operation when n=12 can be expressed as follows:
α^{x}α^{t}=((α^{x})²^{³}α²^{²}^{t}^{₁₁}^{+2t}^{₁₀}^{+t}^{₉})²^{³}α²^{²}^{t}^{₈}^{+2t}^{₇}^{+t}^{₆})²^{³}α²^{²}^{t}^{₅}^{+2t}^{₄}^{+t}^{₃})²^{³}α²^{²}^{t}^{₂}^{+2t}^{₁}^{+t}^{₀} (10)

According to Equation (10), the 2³-th power operation is performed four times.

According to an exemplary implementation, the processing flow of the power-and-multiply method by which a state of an n-stage LFSR is calculated is illustrated in FIG. 8. The processing flow of FIG. 8 can reduce the number of times the state is calculated using a 2^{r}-th power operation when n=rs to s.

Referring to FIG. 8, to reduce the complexity of the 2^{r}-th power operation, an n-tuple vector α²^{^{r}}^{·i}(=Aᵢ) on αⁿ⁻¹, αⁿ⁻², . . . , 1 basis is previously stored for use in step 411. Referring to FIG. 8, a controller or processor (not shown) takes the time of t chips (t=(tₙ₋₁tₙ₋₂ . . . tᵢ . . . t₀)₂) among time intervals of a sleep mode to calculate a state of the LFSR after t chips from the current state of the LFSR in step 412. In step 413, the controller maps a PN state to an element β in the GF(2ⁿ). In step 414, the controller sets a parameter i to 0. In step 415, the controller sets a parameter j to 0 and a parameter y to 0.

For the 2^{r}-th power operation, a bitwise exclusive logic OR operation y=y⊕Aⱼ is performed for all j for 0≦j≦n−1 only when bᵢ=1 in steps 416 through 418.

After every 2^{r}-th power operation, a shift operation β=(β<<1)modf(x) by tₚ(≦2^{r}−1) is performed in steps 419 through 422. f(x) in step 421 indicates a characteristic polynomial satisfying f(α)=0. If y represent a state of LFSR, step 421 corresponds to the same operation as shift the LFSR by one chip or y=y·α.

In step 423, the controller increases (i) by 1. Such an operation of the controller is repeated until it is determined that (i) is not less than s in step 424. If it is determined that (i) is not less than s, such as, (i) is equal to or greater than s in step 424, the controller writes a PN state corresponding to β 425 and terminates its operation.

The operation according to the processing flow described above loops s·(n+2^{r}−1) times in the worst case and s·(n+2^{r}−1)/2 times on the average. In other words, a method for calculating a state of an LFSR using a power-and-multiply method according to an exemplary embodiment of the present invention can allow more rapid and efficient calculation than a method according to the prior art. Moreover, although the state of the LFSR is mapped to elements of GF(2ⁿ), which are expressed as binaries, in the foregoing exemplary embodiment of the present invention, it may also be mapped to elements of GF(pⁿ), which are expressed as p-adic numbers. It is obvious to those skilled in the art that the state of the LFSR is expressed with p-adic numbers based on the foregoing exemplary embodiment of the present invention and thus a detailed description thereof will not be provided.

In case of representing a state of the LFSR as p-adic numbers, an apparatus for generating a code according to an exemplary embodiment of the present invention comprises a first shift register logic(not depicted) for performing a p^{r}-th power operation with respect to a characteristic polynomial indicating the current state value of the LFSR when n=rs in a finite field GF(pⁿ) when the characteristic polynomial is expressed with elements of the GF(pⁿ) and r and s are selected values, and for performing a bitwise exclusive OR operation with respect to an n-tuple vector α^{P}^{^{r}}^{·j}(=Aⱼ) on αⁿ⁻¹, αⁿ⁻², . . . 1 basis for 0≦j≦n−1 based on a table in which the n-tuple vector is previously stored, α comprises a primitive element of the GF(pⁿ), and a second shift register logic(not depicted) for performing a multiply operation with respect to the result of the p^{r}-th power operation by shifting the LFSR. The first shift register logic and the second shift register logic repeat the p^{r}-th power operation and the multiply operation s times to calculate a new state value of the LFSR after the random time, thereby generating the code.

As an application of an exemplary embodiment of the present invention, a long code PN generator in which n=42 in an IS-95 and Code Division Multiple Access (CDMA)-2000 system can be considered. FIG. 10 illustrates α⁶⁴ⁱ required for a 64-th power operation when r=6. According to an exemplary implementation, to calculate a state of an LFSR after fixed t clocks (shifts), an operation loops 735 times to the maximum and 368 times on the average. According to the prior art, an operation loops 1764 times to the maximum and 882 times on the average.

As described above, an exemplary embodiment of the present invention suggests a method for calculating a state of an m-sequence generator (PN generator) constructed in the form of an LFSR. An exemplary embodiment of the present invention can be applied to, for example, a CDMA terminal. The CDMA terminal repeats operations of stopping a PN generator to reduce power consumption in the sleep mode and waking up from the sleep mode after a predetermined amount of time to receive a message. In order for the CDMA terminal to receive a message after waking up from the sleep mode, the state of the internal memory of the PN generator must be changed to a state that advances the elapsed time from the stop state. To this end, an exemplary embodiment of the present invention can be used.

Thus, an exemplary embodiment of the present invention may increase the rate and efficiency of the calculation of a state of an LFSR after a random time than the prior art.

While the present invention has been shown and described with reference to certain exemplary embodiments thereof, it will be understood by those skilled in the art that various changes in form and details may be made therein without departing from the spirit and scope of the invention. For example, an exemplary embodiment of the present invention can be used in any application field for predicting or calculating the states of registers of an LFSR for a PN generator after a random given time t (or t shifts).

What is claimed is:

1. A method for generating a code after a random time in a communication system using an n-stage binary Linear Feedback Shift Register (LFSR), the method comprising:
defining an element indicating the current state value of the LFSR in a finite field GF(2ⁿ);
performing a 2^{r}-th power operation and a multiply operation with respect to a characteristic polynomial of the LFSR when n=rs in the GF(2ⁿ) where r and s are selected values; and
repeating the 2^{r}-th power operation and the multiply operation s times to calculate a new state value of the LFSR after the random time, thereby generating the code.

2. The method of claim 1, wherein the performing of the 2^{r}-th power operation comprises:
determining an n-tuple vector α²^{^{r}}^{·j}(=Aⱼ) as table information on a αⁿ⁻¹, αⁿ⁻², . . . , 1 basis for 0≦j≦n−1; and
performing a bitwise exclusive OR operation with respect to the n-tuple vector for
wherein 0≦j≦n−1 comprises a primitive element of the GF(2ⁿ).

3. The method of claim 2, wherein the performing of the multiply operation comprises the performing of a shift operation by 2^{r}−1 at most through the LFSR every time after performing the 2^{r}-th power operation.

4. The method of claim 1, wherein the code comprises a Pseudorandom Noise (PN) sequence of a Code Division Multiple Access (CDMA) system.

5. The method of claim 4, wherein the random time indicates time during which a terminal of the CDMA system operates in a sleep mode.

6. An apparatus for generating a code after random time in a communication system using an n-stage binary Linear Feedback Shift Register (LFSR), the apparatus comprising:
a first shift register logic for performing a 2^{r}-th power operation with respect to a characteristic polynomial comprising elements indicating the current state value of the LFSR when n=rs in a finite field GF(2ⁿ) when the characteristic polynomial is expressed with elements of the GF(2ⁿ) and r and s are selected values; and
a second shift register logic for performing a multiply operation with respect to the result of the 2^{r}-th power operation by shifting the LFSR;
wherein the first shift register logic and the second shift register logic repeat the 2^{r}-th power operation and the multiply operation s times to calculate a new state value of the LFSR after the random time, thereby generating the code.

7. The apparatus of claim 6, wherein the first shift register logic performs a bitwise exclusive OR operation with respect to an n-tuple vector α²^{^{r}}^{·j}(=Aⱼ) on a αⁿ⁻¹, αⁿ⁻², . . . , 1 basis for 0≦j≦n−1 based on a table in which the n-tuple vector is previouslystored, a comprises a primitive element of the GF(2ⁿ).

8. The apparatus of claim 7, wherein the second shift register logic performs a shift operation by 2^{r}−1 at most through the LFSR every time after performing the 2^{r}-th power operation.

9. The apparatus of claim 6, wherein the code comprises a Pseudorandom Noise (PN) sequence of a Code Division Multiple Access (CDMA) system.

10. The apparatus of claim 9, wherein the random time indicates time during which a terminal of the CDMA system operates in a sleep mode.

11. A method for generating a code after a random time in a communication system using an n-stage p-ary Linear Feedback Shift Register (LFSR), the method comprising:
defining an element indicating the current state value of the LFSR in a finite field GF(pⁿ) that are expressed as p-adic numbers;
performing a p^{r}-th power operation and a multiply operation with respect to the characteristic polynomial using the LFSR when n=rs in the GF(pⁿ); and
repeating the p^{r}-th power operation and the multiply operation s times to calculate a new state value of the LFSR after the random time, thereby generating the code.

12. An apparatus for generating a code after random time in a communication system using an n-stage p-ary Linear Feedback Shift Register (LFSR), the apparatus comprising:
a first shift register logic for performing a p^{r}-th power operation with respect to a characteristic polynomial indicating the current state value of the LFSR when n=rs in a finite field GF(pⁿ) when the characteristic polynomial is expressed with elements of the GF(pⁿ) and r and s are selected values, and for performing a bitwise exclusive OR operation with respect to an n-tuple vector α^{p}^{^{r}}^{·j}(=Aⱼ) on a αⁿ⁻¹, αⁿ⁻², . . . , 1 basis for 0≦j≦n−1based on a table in which the n-tuple vector is previously stored, a comprises a primitive element of the GF(pⁿ); and
a second shift register logic for performing a multiply operation with respect to the result of the p^{r}-th power operation by shifting the LFSR;
wherein the first shift register logic and the second shift register logic repeat the p^{r-}th power operation and the multiply operation s times to calculate a new state value of the LFSR after the random time, thereby generating the code.

13. The apparatus of claim 12, wherein the second shift register logic performs a shift operation by p^{r}−1 at most through the LFSR every time after performing the p^{r}-th power operation.

14. The apparatus of claim 12, wherein the code comprises a Pseudorandom Noise (PN) sequence of a Code Division Multiple Access (CDMA) system.

15. The apparatus of claim 14, wherein the random time indicates time during which a terminal of the CDMA system operates in a sleep mode.
